(19) United States
(12) Patent Application Publication
(10) Pub. No.: US 2014/0250375 A1
(43) Pub. Date: Sep. 4, 2014

(54) METHOD AND SYSTEM FOR SUMMARIZING DOCUMENTS

(71) Applicant: XEROX CORPORATION, Norwalk, CT (US)

(72) Inventor: Amal Z Malik, Pittsford, NY (US)

(73) Assignee: XEROX CORPORATION, Norwalk, CT (US)

(21) Appl. No.: 13/783,470

(22) Filed: Mar. 4, 2013

(51) Int. Cl. G06F 17/21

(52) U.S. Cl. CPC G06F 17/211
USPC 715/254

(57) ABSTRACT

A method and system for creating a summary report for an electronic document is disclosed. An input for specifying one or more sections of an electronic document is received through a graphical user interface (GUI). Further, an input for specifying a type of the summary report for the specified one or more sections is received from the GUI. Thereafter, the summary report is created based on the specified one or more sections and the specified type of the summary report.

### TECHNICAL FIELD

The presently disclosed embodiments are related to summarizing documents. More particularly, the presently disclosed embodiments are related to a method and system for generating textual and/or pictorial summary of an electronic document.

### BACKGROUND

Summarizing electronic documents or generating summaries of scanned documents is needed where a huge set of electronic documents (e.g., the scanned documents or already existing/stored electronic documents) will be archived and used for later analysis. A summary of a huge set of the scanned documents or an electronic document containing large number of pages would ease the understanding of the content to a large extent.

### SUMMARY

According to embodiments illustrated herein, there is provided a graphical user interface (GUI) for facilitating the creation of a summary report. The GUI is displayable on a display associated with an electronic system. The GUI includes a first option for specifying one or more pages of an electronic document. The GUI also includes a second option for specifying a type of the summary report for the specified one or more pages, wherein the type of the summary report comprises a textual summary, a pictorial summary, or a mix summary.

According to embodiments illustrated herein, there is provided a method implemented on an electronic system for creating a summary report. The method includes receiving an input for specifying one or more pages of an electronic document. An input for specifying a type of the summary report for the specified one or more pages is also received, wherein the type of the summary report comprises a textual summary, a pictorial summary, or a mix summary. The inputs for specifying one or more pages and the type of the summary report are receivable through one or more GUIs. Thereafter, the summary report is created based on the specified one or more pages and the specified type of the summary report.

According to embodiments illustrated herein, there is provided an electronic system for creating and displaying through a graphical user interface (GUI) a summary report for an electronic document. The electronic system includes a user interface manager and a summary creation module. The user interface manager is configured for displaying the graphical user interface (GUI) for receiving an input for specifying one or more pages of the electronic document and an input for specifying a type of the summary report. The type of the summary report comprises a textual summary, a pictorial summary, or a mix summary. The summary creation module is configured for creating the summary report based on the specified one or more pages and the specified type of the summary report.

### BRIEF DESCRIPTION OF DRAWINGS

The accompanying drawings illustrate various embodiments of systems, methods, and various other aspects of the invention. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment, in accordance with at least one embodiment;

FIGS. 2A-2G depict various GUIs for facilitating the creation of a summary report for an electronic document, in accordance with at least one embodiment;

FIG. 3 is a flow diagram illustrating a method for pre-processing an electronic document, in accordance with at least one embodiment;

FIGS. 4A-4C are flow diagrams illustrating a method for creating a summary report for an electronic document, in accordance with at least one embodiment; and

FIG. 5 is a block diagram illustrating an electronic system for creating a summary report for an electronic document.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “multifunction device” (MFD) refers to a device that can perform multiple functions. Examples of the functions include, but are not limited to, printing, scanning, copying, faxing, emailing, and the like.

An “electronic document” or “scanned document” or “digital image” refers to information recorded in a manner that requires a computing device or other electronic device to display, interpret, and process it. Electronic documents are intended to be used in either an electronic form or as printed output. In an embodiment, the electronic document includes one or more of text (handwritten or typed), image, symbols, and so forth. In an embodiment, the electronic document is obtained by scanning a document using a suitable scanner or an MFD. In an embodiment, the scanned document is a digital image. The digital image refers to a collection of data, including image data in any format, retained in an electronic form. The digital image can contain one or more pictorial, symbols, text, line art, blank, or non-printed regions, etc. The digital image can be stored in various file formats, such as, JPG or JPEG, GIF, TIFF, PNG, BMP, RAW, PSD, PSP, PDF, and the like. Hereinafter, the terms “electronic document”, “scanned document”, “image”, and “digital image” are interchangeably used without departing from the scope of the ongoing description.

A “computing device” refers to a computer, a device including a processor/microcontroller and/or any other electronic component, or a device or a system that performs one or more operations according to one or more programming instructions. Examples of the computing device include, but are not limited to, a desktop computer, a laptop, a personal digital assistant (PDA), a smart phone, a tablet computer (e.g., iPad®, Samsung Galaxy Tab®), and the like. The computing device is capable of accessing (or being accessed over) a network (e.g., using wired or wireless communication capabilities).

A “network” refers to a medium that interconnects various computing devices, MFD, and server. Examples of the network include, but are not limited to, LAN, WLAN, MAN, WAN, and the Internet. Communication over the network may be performed in accordance with various communication protocols such as Transmission Control Protocol and Internet Protocol (TCP/IP), User Datagram Protocol (UDP), and IEEE 802.11n communication protocols.

“Scanning” refers to a technique of recording an image as digital data in any format, thereby creating a file.

“Graphical User Interface” OR “GUI” refers to an interface that facilitates a user to interact with associated computing devices or MFD. The user can interact with the GUI using various input mediums/techniques including, but not limited to, a keypad, mouse, joystick, any touch-sensitive medium (e.g., a touch-screen or touch sensitive pad), voice recognition, gestures, video recognition, and so forth. In embodiment, the GUI can be displayed on a touch-screen and the user can interact with the GUI using the touch-screen. In an embodiment, the GUI is a Local User Interface (LUI), i.e., displayable on a local display of an MFD or an image-scanning equipment (e.g., scanner). In an embodiment, the GUI is a Remote User Interface (RUI), i.e., displayable on a display of any computing device connected to the MFD or the image-scanning equipment. In an embodiment, the GUI is Web User Interface (WUI), i.e., displayable on a web-page.

An “Optical Character Recognition” or “OCR” operation refers to the conversion of scanned images of handwritten, typewritten, or printed text into machine-encoded text.

“Section” refers to a portion of a larger composition. The composition may correspond to electronic documents, such as, a word-processing document, a power point presentation containing slides, a spreadsheet document, video data, content of a website having one or more web-pages, a webpage, a webblog, and the like. Thus, the section may correspond to at least one page of a word-processing document, a topic from the page, a slide or part of a slide from the power point presentation, a worksheet or part of a worksheet from the spreadsheet document, a webpage of the website, a topic from the webpage, and the like.

“Mixed Raster Content” or “MRC” or “N-Layer MRC” or 3 layer MRC or any other MRC method where text is separated out from the rest of the image content in the electronic document refers to a method/technique/operation for compressing compound images (e.g., images containing text, image data, various shapes, symbols, and so forth). By applying the MRC method, a compound image is converted to an image having multiple layers/planes depending on the content in the compound image. The layers are then compressed using suitable techniques. In an embodiment, the number of text layers can vary from 1 to N. Usually, N is kept to 256 for an optimal file size of the resultant image. However, any number of layers can also be possible without limiting the scope of the ongoing description. The MRC method of text/pictorial separation is useful for OCR and can subsequently be used for generating a summary report.

A “textual summary” is a type of summary report that contains text including various alphabetic characters, numeric characters, symbols, and the like.

A “pictorial summary” is a type of summary report that contains pictorial content i.e. pictures, not text (may be scaled down in size).

A “mix summary” is a type of summary report that contains both text and pictorial content, i.e., pictures.

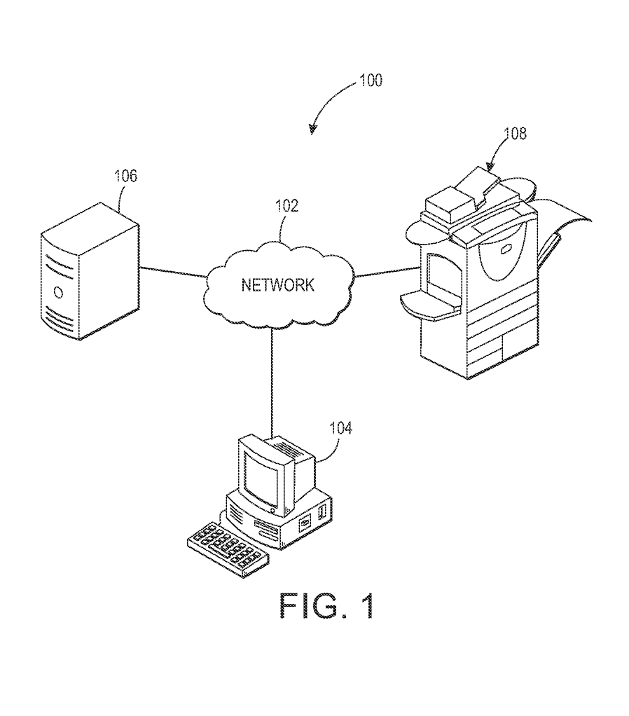

FIG. 1 is a block diagram illustrating a system environment 100, in accordance with at least one embodiment. The system environment 100 includes a network 102, a computing device 104, a server 106, and an MFD 108. Although FIG. 1 shows a single computing device (e.g., desktop computer) for simplicity, the disclosed embodiments can be implemented for a large number of computing devices including, but not limited to, laptops, smart phones, PDAs, and various similar handheld devices. Similarly, other devices such as printers or scanners can be present in the system environment 100 for facilitating associated functionalities.

A user operating the computing device 104 is capable of accessing the MFD 108 and/or the server 106 through the network 102 or directly (i.e., physical access). A functionality of facilitating the creation of a summary report for an electronic document can be implemented on at least one of the computing device 104, the MFD 108, or the server 106. In an embodiment, for example, the computing device 104 is configured to execute an application for facilitating creation of the summary report. In another embodiment, the application is hosted by the server 106 and the computing device 104 is capable of accessing the application over the network 102. In another embodiment, the MFD 108 or the computing device 104 is adapted to facilitate creation of the summary report.

The computing device 104 and the MFD 108 include associated displays for displaying various GUIs through which any user can interact with them for creating the summary report.

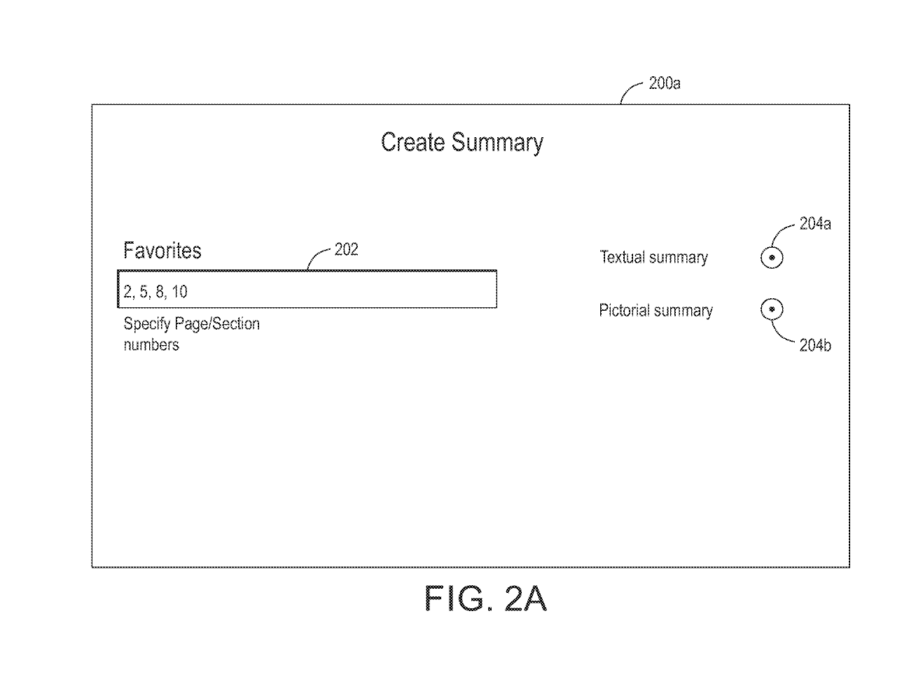

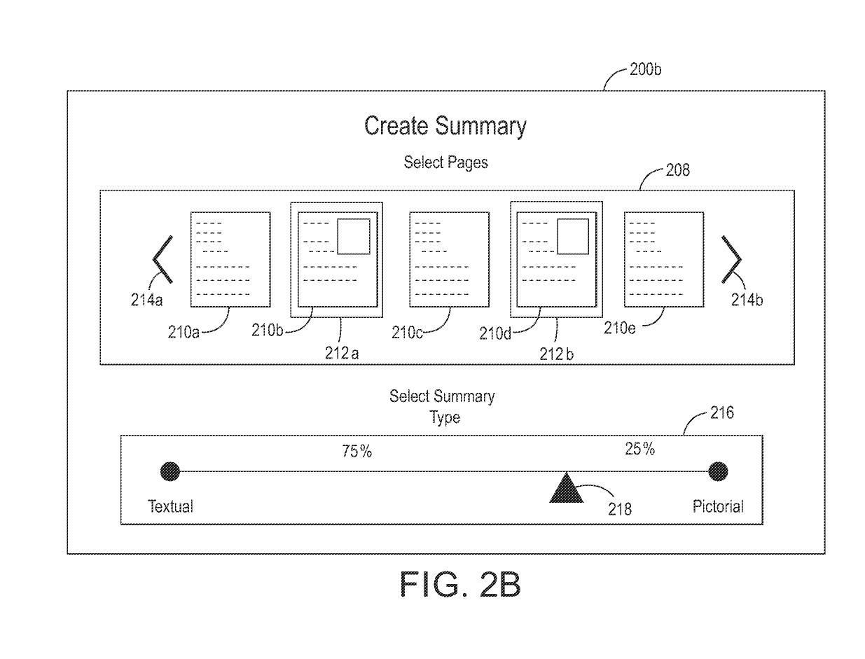

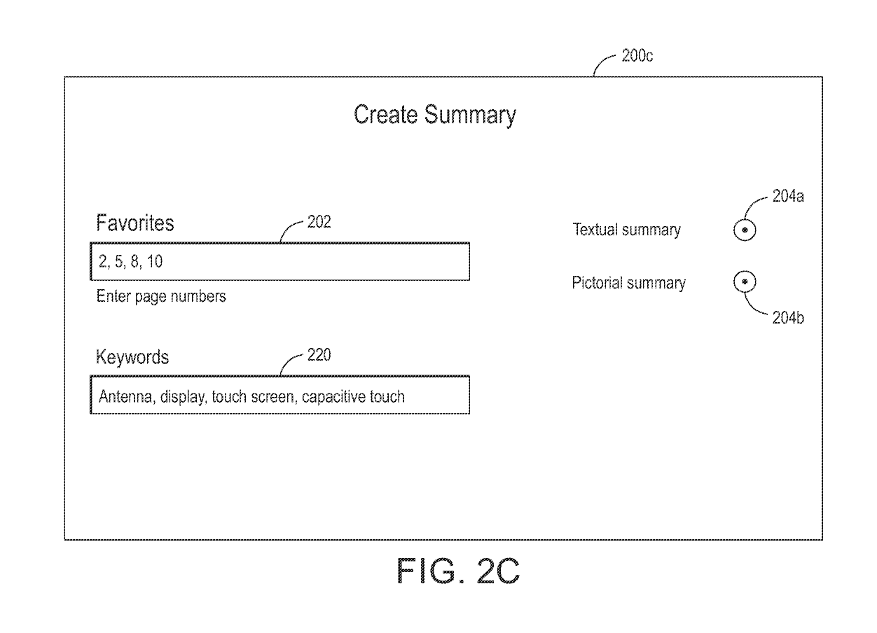

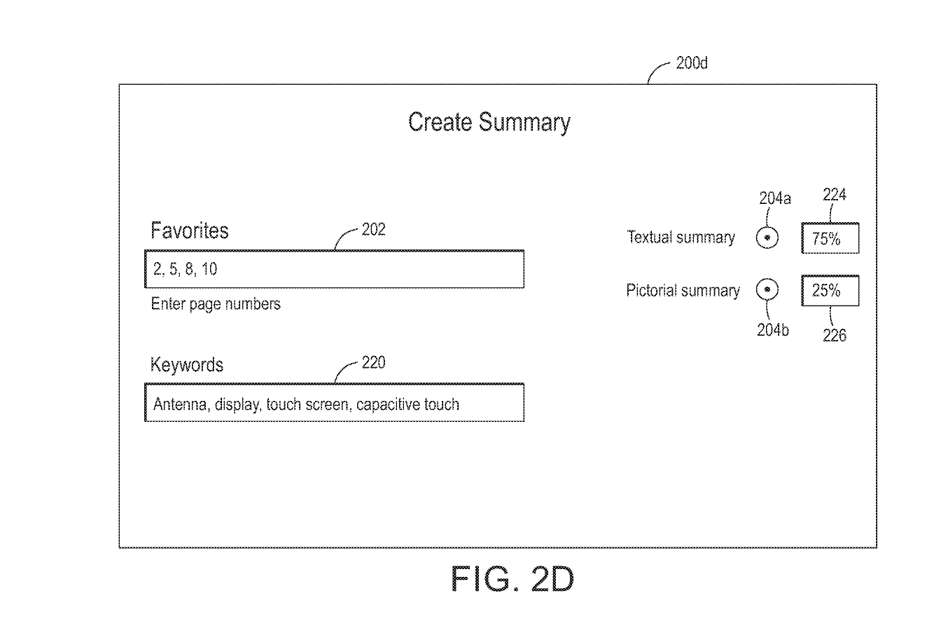

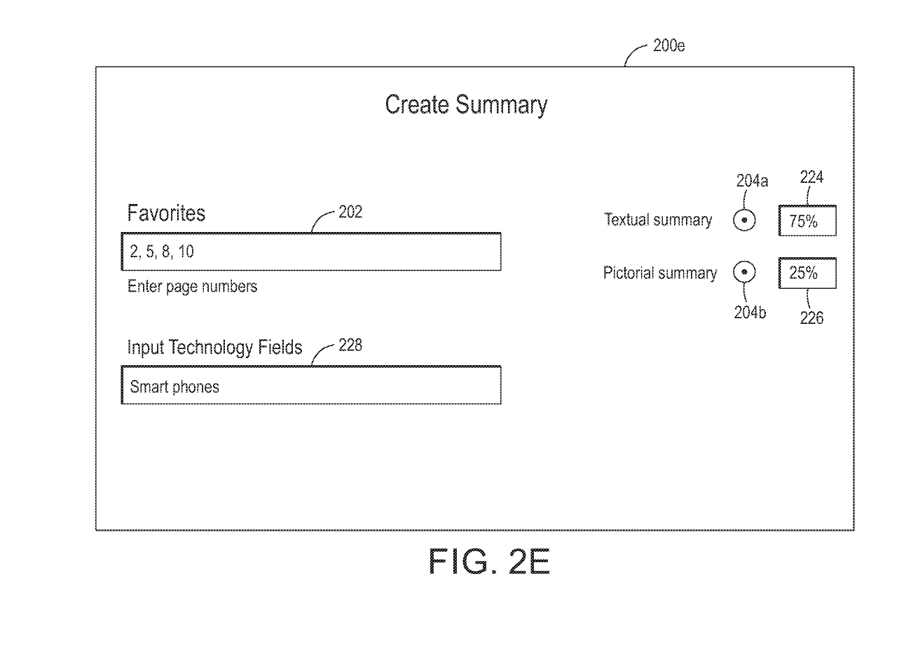

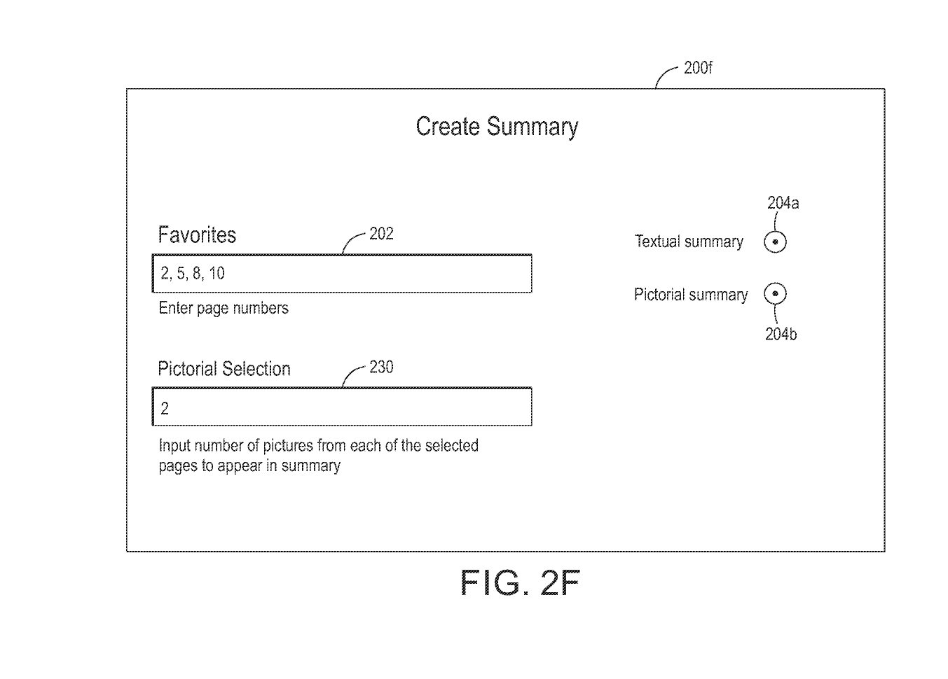

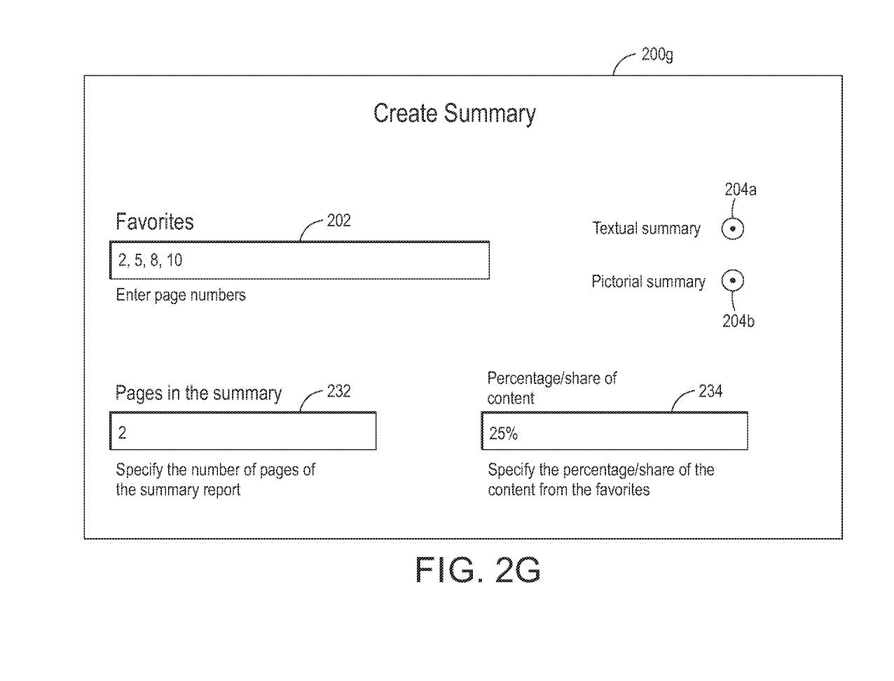

FIGS. 2A-2G depicts various GUIs (200a-200g) for facilitating the creation of the summary report for an electronic document, in accordance with at least one embodiment.

FIG. 2A depicts the GUI 200a through which the user can specify the type of the summary report and specify sections of the electronic document to be used for generating the summary report, in accordance with an embodiment. As already defined, the section corresponds to at least one of a page of a word-processing document, a topic from the page, a slide from the power point presentation, a worksheet or part of the worksheet from the spreadsheet document, a webpage of the website, a topic from the webpage. For simplicity of explanation, the GUIs (200a-200g), method, and system for generating the summary report are described considering a page as an example of the section. It would be apparent to a person having ordinary skilled in the art that it does not limit the scope of the ongoing description in any manner. Various embodiments of the GUIs, methods, and systems pertaining to page are also applicable to other possible examples (such as, the topic from the page, the slide from the presentation, the worksheet from the spreadsheet document, the webpage of the website, a topic from the webpage, and the like) of the section.

The GUI 200a includes an option 202 for facilitating input specifying the page numbers or, sections on the pages for summary generation. Although FIG. 2A shows a text box as an example for the option 202, it will be apparent to a person having ordinary skills in the art that the option 202 can also be realized through various other types of input components/objects, such as, a drop-down menu, a set of radio buttons, a set of check boxes, a set of thumbnails of pages of the electronic document (refer to FIG. 2B), and the like, without departing from the scope of the ongoing description.

The GUI 200a also includes options 204a and 204b for facilitating input specifying the type of summary report for the specified pages. Although FIG. 2A shows radio buttons as an example for the options 204a and 204b, it will be apparent to a person having ordinary skills in the art that the options 204a and 204b can also be realized through various other types of input components, such as, a text box, a drop-down menu, a set of radio buttons, a set of check boxes, a set of slide bars (refer to FIG. 2B), a set of icons, and the like, without departing from the scope of the ongoing description.

In an embodiment, the options 204a and 204b are selectable simultaneously. When both 204a and 204b are selected, the type of summary indicated would be a mix summary. In another embodiment, a separate option can be provided for selecting a mix summary containing textual and pictorial content (e.g., a radio button labeled “Mix of textual and pictorial”, not shown in the FIG. 2A).

FIG. 2B depicts the GUI 200b through which the user can specify the type of the summary report and specify the pages of the electronic document for generating the summary report, in accordance with an embodiment. The GUI 200b includes an option 208 that facilitates the user to specify the pages for generating the summary report. The option 208 displays thumbnails of the pages of an electronic document for which the summary report is to be prepared. The thumbnails of the pages are navigated by activating (e.g., by clicking on) scroll components 214a (for navigating left) and 214b (for navigating right). In an embodiment, by clicking on particular thumbnails, the corresponding pages of the electronic document are selected for creating the summary report. Markings 212a and 212b indicates the selected pages of the electronic documents. In an embodiment, when user clicks any thumbnail, the corresponding page will be displayed so that the user can view the content of the page and decide whether to select that page or not.

Further, the type of summary report for the specified one or more pages can be specified using a slide bar 216. By moving the position of a pointer 218, a pictorial, textual, or combination of the pictorial and textual (e.g., the mix summary) type of summary can be specified. For example, the position of the pointer 218 at the left most (e.g., at the point indicated by textual) indicates a complete textual summary (without any pictorial content). Similarly, the position of the pointer 218 at the right most (e.g., at the point indicated by pictorial) indicates a complete pictorial summary (without any textual content). As depicted in the FIG. 2B, the position of the pointer 218 indicates the mix summary—75% textual and 25% pictorial (i.e., 75% textual and 25% pictorial content will be included in the summary report).

FIG. 2C depicts the GUI 200c through which the user can specify one or more keywords, in accordance with an embodiment. The GUI 200c, in addition to the options 202, 204a, and 204b, includes an option 220 (e.g., a text box) for facilitating input of various keywords. Although FIG. 2C shows a text box as an example for the option 220, it will be apparent to a person having ordinary skills in the art that the option 220 can also be realized through various other types of input components, such as, a drop-down list of keywords, a display of selectable keywords, and the like, without deviating from the scope of the ongoing description.

FIG. 2D depicts the GUI 200d through which the user can specify the type of the summary report and specify the pages of the electronic document for generating the summary report, in accordance with an embodiment. FIG. 2D depicts the GUI 200d having various options as depicted in the GUIs 200a and 200c, the explanation of which is not repeated for the sake of brevity. Options 224 and 226 facilitate the input of percentages of the textual and pictorial content, respectively, in the summary report. The user can input desired values in the options 224 and 226. In an embodiment, the value of one of the options (224, 226) is calculated based on the value already inputted by the user in other option. For example, if the user specifies 75% in the option 224, then the value of the option 226 is determined as 25%. In another embodiment, the values of the option (224, 226) are independent and can be specified by the user. If the user specifies 100% in the option 224, then only the textual summary type is generated. Same holds true for option 226 for pictorial summary generation.

In an embodiment, the options 224 and 226 are displayed when the user selects both textual and pictorial summaries by activating the options 204a and 204b, respectively. In another embodiment, all options (202, 204a, 204b, 220, 224, and 226) in the GUI 200d are displayed simultaneously.

FIG. 2E depicts the GUI 200e through which the user can specify technology fields, in accordance with an embodiment. FIG. 2E depicts the GUI 200e having various options as depicted in the GUIs 200a, 200c, and 200d, the explanation of which is not repeated for the sake of brevity. The GUI 200e includes an option 228 for facilitating input of various technology fields (e.g., names of technology fields). Although FIG. 2E shows a text box as an example for the option 220, it will be apparent to a person having ordinary skills in the art that the option 220 can also be realized through various other types of input components, such as, a drop-down list of the technologies field names, a display of selectable technologies field names, and the like, without departing from the scope of the ongoing description. It is depicted from the FIG. 2E that the inputted technology field name is “smart phones”.

FIG. 2F depicts the GUI 200f through which the user can specify the number of pictures or amount of pictorial content (not shown) to be selected from each specified pages, in accordance with an embodiment. FIG. 2F depicts the GUI 200f having various options as depicted in the GUIs 200a and 200c, the explanation of which is not repeated for the sake of brevity. The GUI 200f includes an option 230 for facilitating the input of a number of pictures from the pages specified in the option 202 (or 208). Although FIG. 2E shows a text box as an example for the option 220, it will be apparent to a person having ordinary skills in the art that the option 230 can also be realized through various other types of input components, such as, a drop-down menu containing numerical (e.g., 1 to 10), a set of radio buttons, a set of check boxes, and the like, without departing from the scope of the ongoing description. Using the option 230, a common number is specified for all the specified pages. However, various other types of selection objects can also be used to facilitate the input for number of pictures or amount of pictorial content to be included from each specified page. For example, one picture from page 2, no picture from page 5, and three pictures form page 8, and so on.

In an embodiment, the option 230 is displayed when the user selects at least the pictorial summary or the mix summary.

FIG. 2G depicts the GUI 200g through which the user can specify a number of pages of the summary report through an option 232. The GUI 200g also includes an option 234 for specifying the percentage of content to be selected from each specified page. For example, if four pages are specified in the option 202 then the user can input maximum 25% in the option 234. In an embodiment, the maximum value that can be inputted in the option 234 is determined based on the number of pages specified through the option 202. Although FIG. 2G shows text boxes as the options 232 and 234, it will be apparent to a person having ordinary skills in the art that the options 232 and 234 can also be realized through various other types of input components/objects, such as, a drop-down menu, a set of radio buttons, a set of check boxes, and the like, without departing from the scope of the ongoing description.

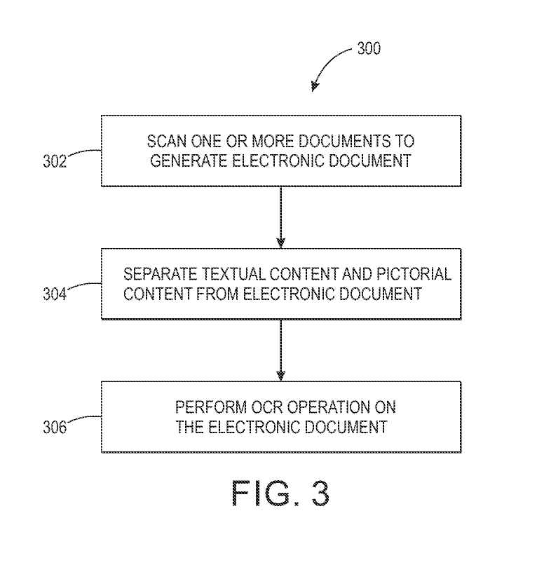

FIG. 3 is a flow diagram 300 illustrating a method for pre-processing the electronic document, in accordance with at least one embodiment.

At step 302, one or more documents are scanned to generate the electronic document.

In an embodiment, the step 302 is optional. For example, if the user wants to generate the summary report for any existing electronic document (e.g., a word-processing document, a presentation containing slides, a spreadsheet document, video data saved on the computing device 104, the MFD 108, or the server 106; or content of the website having one or more web-pages, a webblog, or a webpage), there is no need for scanning and, hence, the step 302 can be avoided.

At step 304, text and pictorial content are separated from the electronic document. Various image processing techniques, such as, an auto windowing technique or mixed raster content (MRC) segmentation technique can be applied to separate the text and images.

At step 306, an Optical Character Recognition (OCR) operation is performed on the electronic document to recognize text contained in the electronic document.

Once the steps 302-306 are performed, a first document containing the text (e.g., machine encoded) separated from the electronic document is obtained.

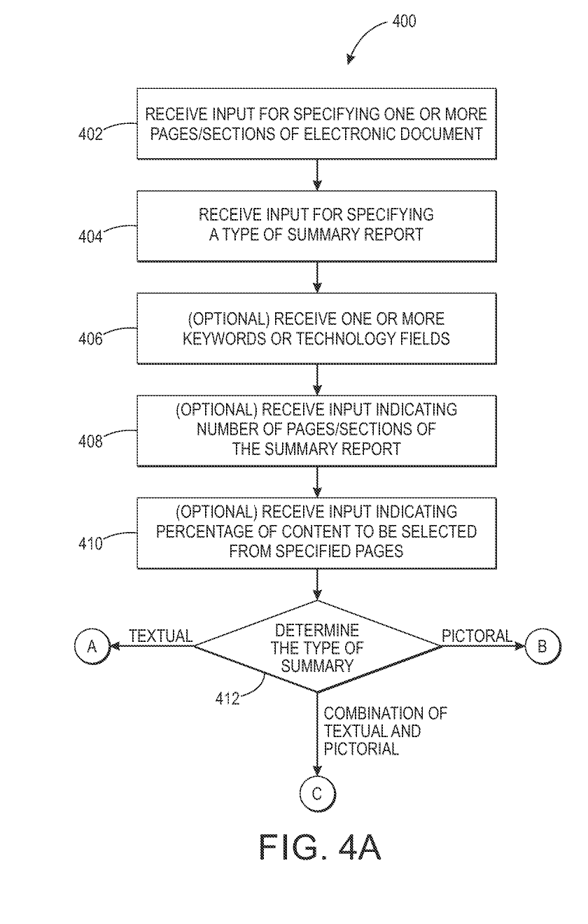

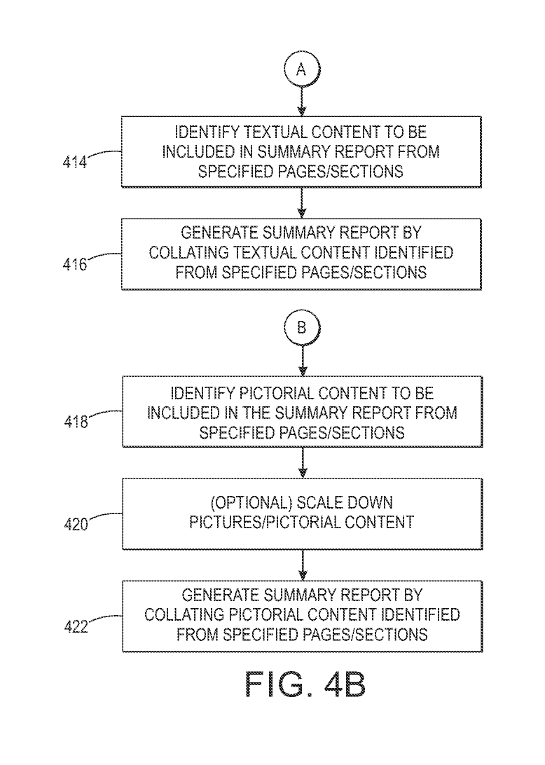

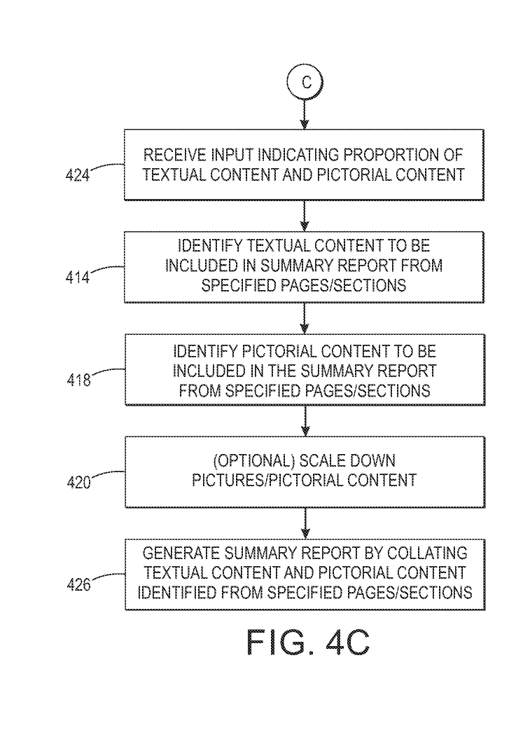

FIGS. 4A-4C is a flow diagram 400 illustrating a method for creating a summary report for the electronic document, in accordance with at least one embodiment.

At step 402, the input for specifying one or more pages (i.e., sections) of the electronic document is received. In an embodiment, the input is received through any of the various GUIs (200a-200g). For example, the user can input the page numbers for creating the summary report using the option 202 in various GUIs (200a, 200c, 200d, 200e, 200f, and 200g). Similarly, the user can select the thumbnails of the pages using the option 208 in the GUI 200b. In an embodiment, the one or more pages to generate the summary report are determined automatically without any user inputs and thus the step 402 may be avoided. In an embodiment, the one or more pages from the electronic document are randomly selected. In another embodiment, the one or more pages are determined based on the keywords inputted (in the option 220) by the user. For example, pages containing the keywords are identified and used to generate the summary report. In another embodiment, the one or more pages are determined based on the technology field names inputted (in the option 228) by the user. For example, pages containing the keywords associated with the technology field names are identified and used to generate the summary report. In another embodiment, the one or more pages are randomly selected.

At step 404, the input for specifying the type of the summary report is received. The type of the summary report can be any of the textual summary, the pictorial summary, or the mix summary. In an embodiment, the input is received through any of the various GUIs (200a-200g) by activating various options (204a, 204b, 224, 226, and 216). For example, if the user activates the option 204a, an input indicating the selection of the textual summary type is received. Similarly, if the user activates the option 204b, an input indicating the selection of the pictorial summary type is received. In an embodiment, the user can also activate both the options 204a and 204b to generate the mix summary having combination of both textual and pictorial content.

At step 406, the one or more keywords or the one or more technology field names are received. As discussed earlier, the one or more keywords are inputted in the option 220 by the user through the appropriate GUIs (200c and 200d). Similarly, the GUI 200e facilitates the input of the one or more technology field names through the option 228. In an embodiment, the step 406 is optional and can be avoided.

At step 408, an input indicating the number of pages/sections of the summary report is received. In an embodiment, the input indicating the number of pages of the summary report is received through the option 232 in the GUI 200g. The summary report will contain the number of pages specified in the option 232.

At 410, an input indicating the percentage of content to be selected from specified pages is received. In an embodiment, the input indicating the percentage of content is received through the option 234 in the GUI 200g. In another embodiment, this percentage can be calculated by using various parameters received as inputs such as 202, 232 and/or 230.

At step 412, the type of the summary report specified by the user (at step 404), is determined. If at step 404, the user activates the option 204a or positions the pointer 218 at the left most end (e.g., at the point indicated by textual) in the option slide bar 216, the type of summary report determined is textual. If at step 404, the user activates the option 204b or positions the pointer 218 at the right most end (e.g., at the point indicated by textual) in the option slide bar 216, the type of the summary report determined is pictorial. If at step 404, the user activates both the options 204a and 204b, positions the pointer 218 anywhere between the leftmost end and the right most end in the option slide bar 216, or selects any separate option provided for selecting the mix summary, the type of the summary report determined is the mix of textual and pictorial.

If it is determined at the step 412 that the type of the summary report is textual, step 414 will be followed.

At step 414, textual content to be included in the summary report is identified from the one or more specified pages/sections (e.g., pages/sections specified through the options 202 or 208). In an embodiment, the first document (e.g., the pre-processed document obtained at the step 306 of the flow diagram 300) is used to identify the textual content.

In an embodiment, a frequency (e.g., number of occurrences) of the words appearing in the specified pages is determined. Thereafter, a set of words with frequency higher than a predefined threshold value are determined. The predefined threshold value may be preconfigured or specifiable by the user through a GUI (not shown). Various sentences or paragraphs containing one or more of the set of words may be considered as the textual content.

In an embodiment, the keywords inputted by the user at the option 220 are taken into consideration for determining the textual content. For example, the text in the specified pages is screened to identify the keywords. Then, the sentences or paragraphs containing the identified keywords are included in the summary report.

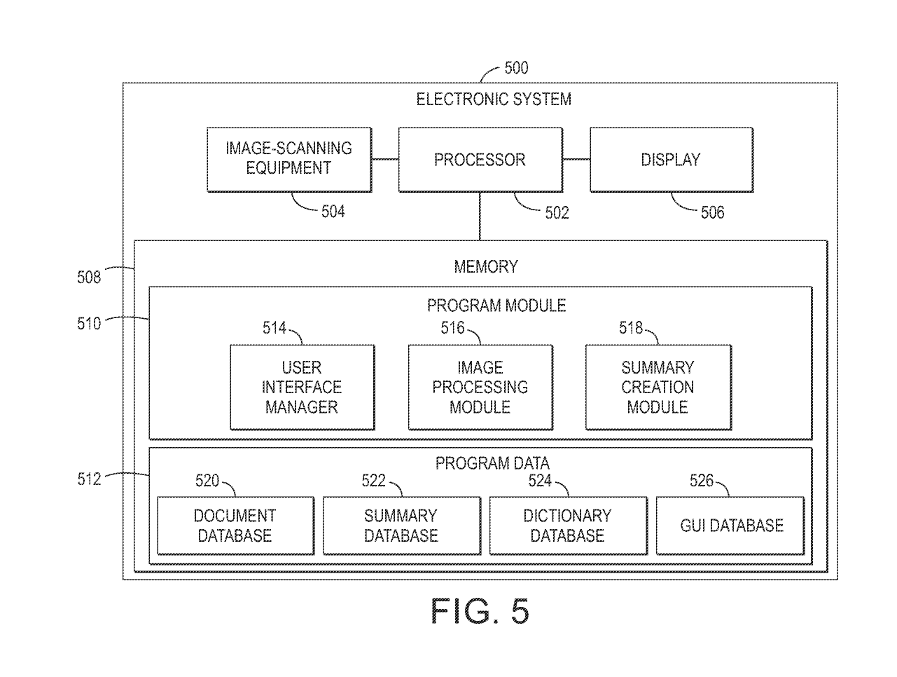

In another embodiment, the technology field names inputted by the user at the option 228 are taken into consideration for determining the textual content. For example, various keywords associated with the inputted technology field names are identified from a dictionary database. The dictionary database is further explained in conjunction with FIG. 5. Thereafter the identified keywords are utilized to generate the summary report. For example, the text in the specified pages at the options 202 or 208 is screened to identify the keywords associated with the technology fields. Then, the sentences or paragraphs containing the identified keywords are included in the summary report.

In another embodiment, the relevant text to be included in the summary report is randomly selected from the extracted text.

In an embodiment, the amount of text to be selected from each page is determined based on the number of pages in the summary report (inputted at the step 408) and/or the number pages specified through the options 202 or 208. For example, as shown in the GUI 200g, the number of pages specified in the option 202 is four (4) and the number of pages of the summary report in the option 232 is one (1). Thus, each page specified (pages 2, 5, 8, 10) in option 202 will be allocated 25% space in the summary report. Therefore, the textual content that can be accommodated in the allocated space is included in the summary report. In another embodiment, any other method may be used to generate a textual summary report.

At step 416, the summary report is generated by collating the textual content identified from the specified pages/sections. In an embodiment, one or more templates of the summary report are stored in a memory. The summary report may be generated in a user specified template from a GUI (not shown).

If it is determined at the step 412 that the type of the summary report is pictorial, step 418 will be followed.

At step 418, pictorial content to be included in the summary report are identified from the one or more specified pages/sections (e.g., pages/sections specified through the options 202 or 208). In an embodiment, the first document (e.g., the pre-processed document obtained at the step 306 of the flow diagram 300) is used to identify the pictorial content.

In an embodiment, the pictorial content is randomly selected from the selected pages.

In another embodiment, pictures with name/title containing the keywords entered by the user are selected as the pictorial content.

In another embodiment, pictures with name/title containing the keywords associated with technology fields entered by the user are selected as the pictorial content.

In another embodiment, various preferences, such as, the number of images provided by the user in the GUI 200f is considered for selected the images. For example, if the user defines two (2) in the option 230, then two images from each of the specified pages will be included in the summary report.

In another example case, if the user specifies the number of pictures corresponding to each specified page, the specified number of pictures is selected from respective pages to generate the summary report.

In another embodiment, if a particular page of the specified pages contains lesser number of pictures or amount of pictorial content than the specified number of pictures or amount of pictorial content in the option 230, the available pictures from that page are included in the summary report.

In another embodiment, if a particular page of the specified pages contains lesser number of pictures than the specified number of pictures in the option 230, the pictures available from the other pages are included in the summary report.

In another embodiment, pictures from the title page (e.g., first page of the electronic document) or pages containing the keywords are selected.

At step 420, the identified pictures are scaled down in size. In an embodiment, the scaling of the pictures is done in accordance with the number of pictures in the specified pages (e.g., pages specified in the option 202 or 208). In another embodiment, the scaling of the pictures is done in accordance with the number of pages of the summary report (specified at step 408). In another embodiment, the scaling of the pictures or pictorial content is done in accordance with both the specified pages and the number of pages of the summary report. In another embodiment, option 230 is also used as a parameter in deciding how the pictorial content is to be scaled.

In an embodiment, if the number of the identified pictorial content is low and can be accommodated in the summary report without scaling down; the step 420 can be avoided.

At step 422, the summary report is generated by collating the pictorial content/pictures identified from the specified pages/sections. In an embodiment, one or more templates of the summary report are stored in a memory. The summary report may be generated in a user specified template from a GUI (not shown). In another embodiment, any other method for generating a pictorial summary report may be employed.

In an embodiment, an option for inputting text keywords in a fully pictorial summary report, is displayed in a GUI (not shown) as well. For example, the user may be prompted with a GUI for entering various text to be included in the pictorial summary.

If it is determined at the step 412 that the type of summary report is the mix summary, step 424 will be followed.

At step 424, the input indicating the proportion of the textual content and the pictorial content is received. In an embodiment, the proportion of the textual content and the pictorial content is selected by the user via the option 216 in the GUI 200b along the selection of the type of the summary. In another embodiment, the proportion of the textual content and the pictorial content is provided by the user by inputting/selecting desired values in the options 224 and 226.

Thereafter, steps 414, 418, and 420 are performed, explanation of which is not repeated herein.

Subsequently, at step 426, the summary report is generated by collating the textual content and the pictorial content/pictures identified from the specified pages. In an embodiment, the relevant text and the relevant pictures are collated in accordance with the defined proportion of the textual content and the pictorial content. In an embodiment, if the user input for specifying the proportion of the textual content and the pictorial content is not received, equal proportion is selected for both the textual content and the pictorial content. In an embodiment, the one or more templates of the summary report are stored in a memory. The summary report may be generated in the user specified template.

In another embodiment, if the user input for specifying the proportion of the textual content and the pictorial content is not received, input from the option 228 may be used to determine the proportion based on same pre-existing templates/database. For example, real estate selection shall yield a 90-100% pictorial summary whereas banking or mortgage selection at option 228 shall yield a 90-100% textual summary. These numbers used here are exemplary and may vary based on the customer/consumer preferences and may be pre-programmed.

FIG. 5 is a block diagram illustrating an electronic system 500 for creating the summary report for an electronic document. The electronic system 500 corresponds to any of the computing device 104, the server 106, or the MFD 108. The electronic system 500 includes a processor 502, image-scanning equipment 504 (optional), a display 506, printing equipment (not shown), a memory 508, and one or more input mediums (not shown). For example, if the electronic system 500 corresponds to the computing device 104 or the server 106, the image-scanning equipment 504 and/or the printing module may not be present. If the electronic system 500 corresponds to the MFD 108, the image-scanning equipment 504 and/or the printing module are present.

The processor 502 executes a set of instructions stored in the memory 508 to perform one or more operations (e.g., various steps disclosed in FIG. 3). The processor 502 can be realized through a number of processor technologies known in the art. Examples of the processor 502 include, but are not limited to, an X86 processor, a RISC processor, an ASIC processor, a CISC processor, or any other processor. In an embodiment, the processor 502 includes a Graphics Processing Unit (GPU) that executes the set of instructions to perform one or more image processing operations.

The memory 508 includes a program module 510 and a program data 512. The program module 510 includes a user interface manager 514, an image processing module 516, and a summary creation module 518. The program data 512 includes a document database 520, a summary database 522, a dictionary database 524, and a GUI database 526.

The memory 508 stores a set of instructions (as the program module 510) and data (as the program data 512). Some of the commonly known memory implementations can be, but are not limited to, a Random Access Memory (RAM), Read Only Memory (ROM), Hard Disk Drive (HDD), and a secure digital (SD) card. The program module 510 includes a set of instructions that are executable by the processor 502 to create the summary report. It is understood by a person having ordinary skill in the art that the set of instructions in conjunction with various hardware of the electronic system 500 enable the electronic system 500 to perform various operations. During the execution of instructions, the document database 520, the summary database 522, the dictionary database 524, and a GUI database 526 may be accessed by the processor 502.

In an embodiment, the image-scanning equipment 504 is capable of scanning documents to generate corresponding electronic documents (e.g., digital images). The image-scanning equipment 504 implements various CCD devices and/or CMOS devices to capture images of scanned documents or electronic documents. In an embodiment, the image-scanning equipment 504 implements a linear scanning technique. In another embodiment, the image-scanning equipment 504 implements a two-dimensional scanning technique. Once the scanning is complete, the image-scanning equipment 504 stores the electronic document (e.g., the scanned document) in the document database 520.

The display 506 facilitates the display of the GUIs (200a-200g) and interaction with the electronic system 500 in conjunction with the input mediums. The display 506 can be realized through several known technologies, such as, Cathode Ray Tube (CRT) based display, Liquid Crystal Display (LCD), Light Emitting Diode (LED)-based display, Organic LED display technology, and Retina Display technology. Further, the display 506 can be a touch-screen capable of receiving user inputs.

The user interface manager 514 facilitates the display of the various GUIs (200a-200g) on the display 506 under the control of the processor 502. In an embodiment, various data (i.e., text to be displayed in any GUI) and options/objects (e.g., text boxes, drop-down lists, radio buttons, various slide bar, and so forth), and information related to the positioning of the data and object for generating the GUIs (200a-200g) are stored in the GUI database 526. The user interface manager 514 accesses the GUI database 526 for displaying the GUIs (200a-200g) on the display 506. Further, the user interface manager 514 receives various inputs provided by the user on the GUIs (200a-200g) and stores them into the GUI database 526.

The image processing module 516 includes a set of instructions for pre-processing the electronic document to generate the first document by separating the text and the images from the electronic document. The image processing module 516 obtains the electronic document from the document database 520. In an embodiment, the image processing module 516 implements the MRC technique (such as an N-Layer MRC operation) on the electronic document (e.g., scanned document) to separate the text and the pictures/pictorial content. Based on the MRC technique, the image processing module 516 extracts the text with different text colors into separate planes.

In another embodiment, the image processing module 516 implements the auto windowing technique to separate the text and the pictures in images of documents. However, it will be apparent to a person having ordinary skill in the art that any other suitable technique for separating the text and the pictorial content can be implemented by the image processing module 516 without limiting the scope of the ongoing description. Thereafter, the image processing module 516 stores the first document (with the separated text and pictorial content) in the document database 520. The method of pre-processing the electronic document is disclosed in FIG. 3.

The summary creation module 518 obtains the user inputs provided at various steps (402-410 and 424 as illustrated in FIG. 3) from the GUI database 526. As discussed earlier, the user inputs are received by the user interface manager 514 and stored in the GUI database 526.

In an embodiment, the summary creation module 518 determines a share of the content of the summary report on the basis of a number of specified pages. For example, if the user selects four pages (e.g., page numbers 2, 5, 8, and 10 inputted in the option 202 in any of the GUIs 200a-200g), the content from each page is allocated 25% share of the content in the summary report. In another example, the share of the content in the summary report for each of the specified pages is different (e.g., 10% for page 2, 30% for page 5, 40% for page 8, and 20% for page 10). In an embodiment, the share of the content in the summary report for each of the specified page is defined by the user in a GUI (not shown).

In an embodiment, the summary report includes more than one page. The summary creation module 518 determines the number pages of the summary report. In an embodiment, the summary creation module 518 receives the data inputted by the user in the option 232 in the GUI 200g, as the number pages of the summary report. In an embodiment, the determination may be based on the number of pages specified by the user for generating the summary report. In another embodiment, the determination may be based on a percentage of the content from each specified page to be included in the summary report. In another embodiment, the determination may be based on both the specified pages and the percentage of the content from each specified page.

The dictionary database 524 stores vocabulary corresponding to various technology fields. In an embodiment, when the GUI 200e is presented to the user by the user interface manager 514 and if any technology field name is inputted by the user, the summary creation module 518 accesses the dictionary database 524 to identify the keywords related to the inputted technology field. For example, as depicted in the GUI 200e, the summary creation module 518 accesses the dictionary database 524 to identify the keywords related to the field of smart phones. Thereafter, the summary creation module 518 searches for the identified keywords in the pages specified by the user to identify various sentences/paragraphs containing the one or more of the identified keywords.

Once the summary report is generated (as disclosed in the FIGS. 4A-4C), the summary creation module 518 stores the summary report in the summary database 522.

The user interface manager 514 obtains the summary report from the summary database 522 and presents the summary report to the user on the display 506.

In another embodiment, the above mentioned methods can be extended to generate summary of weblogs by timeframe, associated person name, subject matter, etc. of entries in a weblog by using keywords specified by the user on the GUI. A weblog is a website comprising entries arranged in order.

In another embodiment, the above mentioned methods can be used for generating summary of videos by timeframe, subject matter, text in videos, and the like. This again can be done using keywords specified by the user on the GUI or some dictionary database.

The disclosed methods and systems, as illustrated in the ongoing description or any of its components, may be embodied in the form of a computer system. Typical examples of a computer system include a general-purpose computer, a programmed microprocessor, a microcontroller, a peripheral integrated circuit element, and other devices, or arrangements of devices that are capable of implementing the steps that constitute the method of the disclosure.

The computer system comprises a computer, an input device, a display unit, and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard disk drive or a removable storage drive, such as, a floppy disk drive, optical disk drive, etc. The storage device may also be a means for loading computer programs or other instructions into the computer system. The computer system also includes a communication unit. The communication unit allows the computer to connect to other databases and the Internet through an Input/output (I/O) interface, allowing the transfer as well as the reception of data from other databases. The communication unit may include a modem, an Ethernet card, or other similar devices, which enable the computer system to connect to databases and networks, such as, LAN, MAN, WAN, and the Internet. The computer system facilitates inputs from a user through an input device, accessible to the system through an I/O interface.

The computer system executes a set of instructions that are stored in one or more storage elements, in order to process input data. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The method and systems described can also be implemented using only software programming or hardware or by a varying combination of the two techniques. The disclosure is independent of the programming language and the operating system used in computers. The instructions for the disclosure can be written in all programming languages including, but not limited to, ‘C’, ‘C++’, ‘Visual C++’, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, results of previous processing, or a request made by another processing machine. The disclosure can also be implemented in various operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

The method, system, and computer program product, as described above, have numerous advantages. Some of these advantages may include, but are not limited to, generating the summary report based on the user's preferences. The user is presented with various GUIs to input his/her preferences for generating the summary report. For example, the user can define his/her favorite pages and the desired type of the summary report, resulting in increased user satisfaction. Further, the pictorial summary can be useful for various industrial areas such as real estate, medical, mechanical, architectural, and so forth. The textual summary can be very useful in the sectors such as banking, human resource, academia, and so forth. Also, saving summary reports of electronic documents is useful for later retrieval of data, and it reduces the time to be invested in understanding the content of the electronic documents.

Various embodiments of the method and the system for creating the summary report have been disclosed. However, it will be apparent to those skilled in the art that many more modifications, besides those described, are possible without deviating from the inventive concepts herein. The embodiments, therefore, are not to be restricted, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skill in the art will appreciate that the system, modules, and sub-modules have been illustrated and explained to serve as examples and should not be considered limiting in any manner. It will be further appreciated that the variants of the above-disclosed system elements, or modules and other features and functions, or alternatives thereof, may be combined to create many other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and are not limited to any particular computer hardware, software, middleware, firmware, microcode, etc.

The claims can encompass embodiments for hardware, software, or a combination thereof.

It will be appreciated that variants of the above disclosed, and other features and functions or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A graphical user interface (GUI) for facilitating creation of a summary report, wherein the GUI is displayable on a display associated with an electronic system, the GUI comprising:
a first option for specifying one or more sections of an electronic document; and
a second option for specifying a type of the summary report for the specified one or more sections, wherein the type of the summary report comprises a textual summary, a pictorial summary, or a mix summary.

2. The GUI of claim 1, wherein the first option corresponds to one of a text box, a drop-down menu, a set of radio buttons, a set of check boxes, or a set of thumbnails of sections of the electronic document.

3. The GUI of claim 1, wherein the second option corresponds to one of a text box, a drop-down menu, a set of radio buttons, a set of check boxes, a set of slide bars, or a set of icons.

4. The GUI of claim 1 further comprising a third option for inputting one or more keywords, wherein the third option corresponds to at least one of a text box or a list of keywords extracted from the electronic document.

5. The GUI of claim 1 further comprising a fourth option for inputting one or more technology fields, wherein the fourth option corresponds to at least one of a text box or a list of predefined technology fields.

6. The GUI of claim 1 further comprising a fifth option for specifying a share of a textual content and a pictorial content in the summary report.

7. The GUI of claim 6, wherein the fifth option is displayable when both the textual summary and the pictorial summary types are specified.

8. The GUI of claim 1 further comprising a sixth option for specifying a number of pictures or amount of pictorial content from the one or more sections to appear in the summary report.

9. The GUI of claim 8, wherein the sixth option is displayable when at least the pictorial summary is specified from the second option.

10. A method implemented on an electronic system for creating a summary report, the method comprising:
receiving an input for specifying one or more sections of an electronic document;
receiving an input for specifying a type of the summary report for the specified one or more sections, wherein the type of the summary report comprises a textual summary, a pictorial summary, or a mix summary, wherein the inputs for specifying the one or more sections and the type of the summary report are receivable through one or more GUIs; and
creating the summary report based on the specified one or more sections and the type of the summary report.

11. The method of claim 10, wherein the electronic document correspond to at least one of a word-processing document, a presentation containing slides, a spreadsheet document, content of the website having one or more web-pages, a weblog, video data, or a webpage.

12. The method of claim 11, wherein the section correspond to at least one of a page of a word-processing document, a topic from the page, a slide or part of a slide from the presentation, a worksheet or part of a worksheet from the spreadsheet document, a webpage of the website, a topic from the webpage.

13. The method of claim 11, wherein the summary report for the weblog is generated based on timeframe, associated person name, subject matter.

14. The method of claim 11, wherein the summary report for the video data is generated based on at least one of timeframe, subject matter, text embedded in the video data.

15. The method of claim 10 further comprising scanning one or more documents to generate the electronic document.

16. The method of claim 10 further comprising separating text and pictures from the electronic document.

17. The method of claim 10 further comprising performing optical character recognition (OCR) operation on the electronic document to recognize text from the electronic document.

18. The method of claim 10 further comprising receiving one or more keywords, wherein creating the summary report comprises identifying text containing the one or more keywords from the specified one or more sections.

19. The method of claim 10 further comprising receiving one or more technology fields.

20. The method of claim 19 further comprising identifying keywords related to the one or more technology fields from a dictionary database.

21. The method of claim 20, wherein creating the summary report comprises identifying text containing the keywords related to the one or more technology fields from the specified one or more sections.

22. The method of claim 10 wherein the summary report comprises at least one page.

23. The method of claim 10, wherein content in the summary report is selected in a predefined proportion form the specified one or more sections.

24. The method of claim 10 further comprising scaling one or more pictures from the one or more sections to generate the summary report.

25. The method of claim 10 further comprising receiving an input for selecting a number of pictures from the one or more sections to appear in the summary report.

26. A method implementable in an electronic system for creating a summary report, the method comprising:
receiving an input for specifying one or more sections of an electronic document;
receiving an input for specifying a type of the summary report for the specified one or more sections, wherein the type of the summary report comprises a textual summary, a pictorial summary, or a mix summary; and
receiving an input for specifying one or more technology fields;
identifying keywords related to the one or more technology fields from a dictionary database, wherein the inputs for specifying the one or more sections, the type of the summary report, and the one or more technology fields are receivable through one or more GUIs; and
creating the summary report based on the specified one or more sections, the type of the summary report, and one or more of the identified keywords or one or more technology fields.

27. The method of claim 26, wherein the input for specifying the one or more technology fields is received through an option displayable on the one or more GUIs, wherein the option corresponds to at least one of a text box or a list of predefined technology fields.

28. The method of claim 26, wherein creating the summary report comprises identifying text containing the keywords related to the one or more technology fields from the specified one or more sections.

29. An electronic system for creating and displaying through a graphical user interface (GUI) a summary report for an electronic document, the electronic system comprising:
a user interface manager configured for displaying the graphical user interface (GUI) for receiving an input for specifying one or more sections of the electronic document and an input for specifying a type of the summary report, wherein the type of the summary report comprises a textual summary, a pictorial summary, or a mix summary; and
a summary creation module configured for creating the summary report based on the specified one or more sections and the type of the summary report.

30. The electronic system of claim 29 further comprising image-scanning equipment configured for facilitating scanning of one or more documents to generate the electronic document.

31. The electronic system of claim 29 further comprising an image processing module configured for separating text and pictures from the electronic document.

32. The electronic system of claim 31, wherein the image processing module implements at least one of an auto windowing technique or a mixed raster content (MRC) segmentation technique.

33. The electronic system of claim 32 further comprising a document database for storing the electronic document and a summary database for storing the summary report.
